(19) United States
(12) Patent Application Publication
(10) Pub. No.: US 2021/0098839 A1
(43) Pub. Date: Apr. 1, 2021

(54) FUNCTIONAL THERMAL INSULATION DEVICE FOR LITHIUM BATTERY

(71) Applicant: SUZHOU YOULIONBATTERY INC., Suzhou (CN)

(72) Inventors: Huanyu MAO, Suzhou (CN); Saifu LONG, Suzhou (CN)

(73) Assignee: SUZHOU YOULIONBATTERY INC.

(21) Appl. No.: 17/120,311

(22) Filed: Dec. 14, 2020

Related U.S. Application Data
(63) Continuation of application No. PCT/CN2018/118956, filed on Dec. 3, 2018.

(30) Foreign Application Priority Data
Aug. 1, 2018 (CN) 201810867491.8

(51) Int. Cl. H01M 10/658; H01M 10/613; H01M 10/653

(52) U.S. Cl. CPC H01M 10/658; H01M 10/653; H01M 10/613

(57) ABSTRACT

The disclosure provides a functional thermal insulation device for a lithium battery, including a functional material which is a material having a fire extinguishing function and a heat absorption and cooling function. The functional thermal insulation device is fixedly mounted on the side face of a lithium ion unit cell. The device can more effectively prevent a heat transfer phenomenon between lithium ion unit cells, reduce energy generated by deflagration of the lithium battery and avoid the ignition of lithium ion unit cells, thereby effectively reducing chain reaction generated by ignition or explosion of the lithium ion battery, and improving the safety performance of the lithium ion battery to a great extent.

### TECHNICAL FIELD

The disclosure relates to the field of lithium ion batteries, and particularly relates to a functional thermal insulation device fora lithium battery.

### BACKGROUND

With the gradual development of new energy automobiles, lithium ion battery has begun to gradually become the dynamic support for automobiles instead of gasoline. However, the safety performance of lithium ion battery greatly restricts the development of electric vehicles. Where, the deflagration caused by short circuit in the lithium ion battery has become the problem to be most urgently solved in the field of power batteries, because its triggering reasons are diverse, the first deflagrated battery has randomness and singleness, the deflagration inducements cannot be completely eliminated and deflagration cannot be detected in advance.

Therefore, research on the short circuit deflagration has currently become an important component for lithium ion battery research and development. In view of the characteristics of the short circuit in the lithium battery, the possibility of thermal runaway caused by short circuit in a unit cell cannot be completely eliminated, while the catastrophic accident of the whole battery can be avoided by preventing heat transfer between unit cells. At present, an ordinary way is to set a thermal insulation film between lithium batteries. However, the thermal insulation film can only achieve a thermal insulation effect but cannot reduce heat. When the thermal insulation film is in a high temperature state for a long time, the temperatures of its two side faces tend to be balanced, and the thermal insulation film will be out of action, and thus the disastrous accidents, namely, batteries are continuously ignited and exploded, are still unavoidable.

Therefore, it is necessary to provide a functional thermal insulation device for a lithium battery. The functional thermal insulation device has a fire extinguishing function and a heat absorption and cooling function, which can effectively prevent heat transfer between lithium ion unit cells.

### SUMMARY

To this end, the disclosure provides a functional thermal insulation device which can effectively prevent heat transfer between lithium ion unit cells.

The disclosure provides a functional thermal insulation device for a lithium battery, comprising a functional material which is a material having a fire extinguishing function and a heat absorption and cooling function, the functional thermal insulation device being fixedly mounted on the side face of a lithium ion unit cell.

Further, the functional material comprises, but is not limited to, a nitrogen-containing organic compound, polyhydric alcohol and/or inorganic ammonium phosphate, and aqueous solution thereof.

Further, the functional material comprises, but is not limited to, the following materials by weight percent: 20-40% of nitrogen-containing organic compound, 20-40% of polyhydric alcohol and 20-40% of inorganic ammonium phosphate.

Further, the functional material comprises, but is not limited to, the following materials by weight percent: 40-60% of nitrogen-containing organic compound and 40-60% of polyhydric alcohol.

Further, the functional material comprises, but is not limited to, the following materials by weight percent: 40-60% of nitrogen-containing organic compound and 40-60% of inorganic ammonium phosphate.

Further, the functional material comprises, but is not limited to, the following materials by weight percent: 40-60% of polyhydric alcohol and 40-60% of inorganic ammonium phosphate.

Further, the nitrogen-containing organic compound comprises, is not limited to, tripolycyanamide and/or urea.

Further, the polyhydric alcohol comprises, but is not limited to, dipentaerythritol.

Further, the inorganic ammonium phosphate comprises, but is not limited to, ammonium polyphosphate and/or ammonium dihydrogen phosphate.

Further, the functional material is of a solid state or liquid state or solid-liquid mixed state.

The disclosure provides a functional thermal insulation device for a lithium battery. The functional thermal insulation device contains a functional material having a fire extinguishing function and a heat absorption and cooling function. When the lithium ion battery is detonated, high temperature allows the functional material to be in contact with the fiery battery so as to be rapidly decomposed.

1. The functional material has the functions of heat absorption and cooling. The decomposition of the functional material is heat absorption reaction which can absorb a large amount of energy and reduce the high temperature generated by the deflagration of the lithium ion battery, thus reducing the explosion power, and avoiding the chain explosion of the lithium ion battery to a certain extent. In addition, the decomposition product of the functional material enters organic solvent vapor-containing combustible dense smoke generated by explosion, which increases the humidity of the organic solvent vapor-containing combustible dense smoke, the temperature of the surrounding environment is reduced, increases the flash point of the organic solvent vapor-containing combustible dense smoke produced by the deflagration of the lithium battery, avoids the ignition of the organic solvent vapor-containing combustible dense smoke by sparks generated during explosion, and avoids continuous ignition of the lithium-ion battery to a certain extent.

2. The functional material has the fire extinguishing function. The decomposition product of the functional material enters into the organic solvent vapor-containing combustible dense smoke generated by explosion, which reduces the concentration of oxygen in the combustible dense smoke. The reduction in oxygen content can cause reduction in a heat generation rate when in combustion. When the heat generation rate is reduced to be lower than a heat loss rate, the combustion will stop, further avoiding the chain reaction generated by ignition or explosion of the lithium ion battery.

Therefore, addition and arrangement of the functional thermal insulation device on the side face of the lithium ion battery can effectively prevent the heat transfer between unit cells, reduce the energy generated by deflagration of the lithium ion battery, and avoid the ignition of the lithium ion battery, so as to effectively reduce the chain reaction caused by ignition or explosion of the lithium ion battery, and greatly improve the safety performance of the lithium ion battery to a great extent.

### BRIEF DESCRIPTION OF THE DRAWINGS

Through reading the detailed descriptions of preferred embodiments below, various other advantages and benefits will become clear to those skilled in the art. Drawings are only for the purpose of illustrating the preferred embodiments, but not intended to limit the disclosure. Moreover, throughout the drawings, the same reference numbers represent the same components. In the drawings:

FIG. 1 is a structural diagram of a functional thermal insulation device for a lithium battery provided by an example of the disclosure.

### DESCRIPTION OF THE EMBODIMENTS

Next, the exemplary examples of the disclosure will be described in detail by referring to drawings. Although the drawings exhibit the exemplary examples of the disclosure, however, it should be understood that the disclosure can be achieved in various forms but should not be limited by examples described here. On contrary, provision of these examples is to more thoroughly understand the disclosure, and can completely convey the scope of the disclosure to those skilled in the art.

### EXAMPLE 1

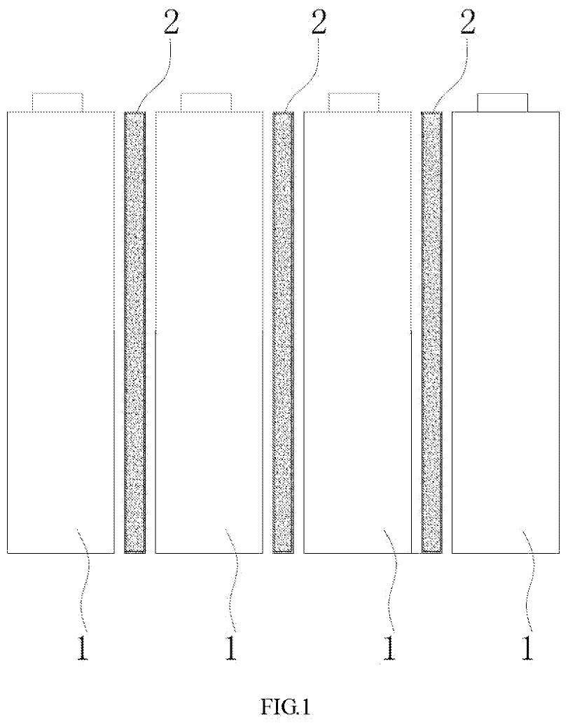

Referring to FIG. 1, it shows a structural diagram of a functional thermal insulation device for a lithium battery provided by an example of the disclosure. When in specific installation, a functional thermal insulation device 2 can be fixedly mounted on the side face of a lithium ion battery 1, and the functional thermal insulation device 2 contains a functional material having a fire-extinguishing function and a heat absorption and cooling function.

Specific components of the functional material of the disclosure trend to the descriptions of the following examples.

| | | | | | Ammonium |
|---|---|---|---|---|---|
| | | | | Ammonium | dihydrogen |
| Example | Melamine | Urea | Dipentaerythritol | polyphosphate | phosphate |
| 1 | 100% | | | | |
| 2 | | 100% | | | |
| 3 | | | 100% | | |
| 4 | | | | 100% | |
| 5 | | | | | 100% |
| 6 | 50% | | 50% | | |
| 7 | 40% | | 60% | | |
| 8 | 50% | | | 50% | |
| 9 | 60% | | | 40% | |
| 10 | 50% | | | | 50% |
| 11 | 40% | | | | 60% |
| 12 | | 50% | 50% | | |
| 13 | | 60% | 40% | | |
| 14 | | 50% | | 50% | |
| 15 | | 40% | | 60% | |
| 16 | | 50% | | | 50% |
| 17 | | 60% | | | 40% |
| 18 | 50% | 50% | | | |
| 19 | 40% | 60% | | | |
| 20 | 20% | 20% | 20% | 20% | 20% |
| 21 | 10% | 30% | 20% | 30% | 10% |
| 22 | 30% | | 40% | 30% | |
| 23 | 40% | | | 30% | 30% |
| 24 | 30% | | 30% | | 40% |
| 25 | | 40% | 30% | 30% | |
| 26 | | 30% | | 40% | 30% |
| 27 | | 30% | 40% | | 30% |

With continued reference to FIG. 1, it shows that when a thermal insulation device 2 for a functional lithium battery provided by an example of the disclosure is applied to a lithium ion battery pack, the lithium ion battery pack has a plurality of lithium ion batteries 1, and the functional thermal insulation device 2 is arranged on the sides of the lithium ion batteries 1. When in specific installation, a gap can be set between two adjacent lithium ion batteries, and the functional thermal insulation device 2 is provided in the gap.

To sum up, this example provides a functional thermal insulation device for a lithium battery. This device contains a functional materials having the fire extinguishing function and the heat absorption and cooling function. When the lithium ion battery is deflagrated, the high temperatures allows the functional material to be in contact with the fiery battery to be rapidly decomposed.

1. The functional material has the functions of heat absorption and cooling. The decomposition of the functional material is heat absorption reaction which can absorb a large amount of energy and reduce the high temperature generated by the deflagration of the lithium ion battery, thus reducing the explosion power and avoiding the chain explosion of the lithium ion battery to a certain extent. In addition, the decomposition product of the functional material enters the organic solvent vapor-containing combustible dense smoke generated by explosion, which increases the humidity of the organic solvent vapor-containing combustible dense smoke, reduces the temperature of the surrounding environment, increases the flash point of the organic solvent vapor-containing combustible dense smoke produced by the deflagration of the lithium battery avoids the ignition of the organic solvent vapor-containing combustible dense smoke by sparks and sparks generated during explosion, and avoids the continuous ignition of the lithium ion battery to a certain extent.

2. The functional material has the fire extinguishing function. The decomposition product of the functional material enters the organic solvent vapor-containing combustible dense smoke generated by explosion, which reduces the oxygen concentration in the combustible dense smoke. The reduction in oxygen content can cause reduction in the heat generation rate when in combustion. When the heat generation rate is reduced to be lower than the heat loss rate, the combustion will stop, further avoiding the chain reaction generated by ignition or explosion of the lithium ion battery.

Therefore, addition and arrangement of the functional thermal insulation device on the side of the lithium ion battery can effectively prevent the heat transfer between unit cells, reduce the energy generated by deflagration of the lithium ion battery, and avoid the ignition of the lithium ion unit cell, so as to effectively reduce the chain reaction caused by ignition or explosion of the lithium ion battery, and greatly improve the safety performance of the lithium ion battery to a great extent

### EXAMPLE 2

Compared with example 1, the unique difference of this example is that a leakproof outer package is arranged outside the functional material. When in specific installation, in at least one case, the leakproof outer package can be fixedly mounted on the side face of the lithium ion battery 1, and this leakproof outer package is internally equipped with the corresponding functional material which is, a material having the fire extinguishing function and the heat absorption and cooling function.

In at least one case, in order to facilitate the use of the functional material, the leakproof outer package can be arranged outside the functional material, and this leakproof outer package can specifically be a self-sealing bag. To further ensure the sealing performance, the self-sealing bag can also be provided with a sealing part which can specifically be a cover plate or a sealing clip to improve the sealing performance of the leakproof outer package and prevent the functional material from leaking into the battery pack before explosion to affect the normal use of the battery.

Obviously, those skilled in the art can make various modifications and deformations on the disclosure without departing from the spirit and scope of the disclosure. In this way, if these modifications and deformations of the disclosure fall within the scope of claims and their equivalents of the disclosure, the disclosure is also intended to include these modifications and deformations.

What is claimed is:

1. A functional thermal insulation device for a lithium battery, comprising a functional material which is a material having a fire extinguishing function and a heat absorption and cooling function, and the functional thermal insulation device is fixed and mounted on the side face of a lithium ion unit cell.

2. The functional thermal insulation device for a lithium battery according to claim 1, wherein the functional material comprises, but is not limited to, a nitrogen-containing organic compound, polyhydric alcohol and/or inorganic ammonium phosphate, and aqueous solution.

3. The functional thermal insulation device for a lithium battery according to claim 2, wherein the functional material comprises, but is not limited to, the following materials by weight percent: 20-40% of nitrogen-containing organic compound, 20-40% of polyhydric alcohol and 20-40% of inorganic ammonium phosphate.

4. The functional thermal insulation device for a lithium battery according to claim 2, wherein the functional material comprises, but is not limited to, the following materials by weight percent: 40-60% of nitrogen-containing organic compound and 40-60% of polyhydric alcohol.

5. The functional thermal insulation device for a lithium battery according to claim 2, wherein the functional material comprises, but is not limited to, the following materials by weight percent: 40-60% of nitrogen-containing organic compound and 40-60% of inorganic ammonium phosphate.

6. The functional thermal insulation device for a lithium battery according to claim 2, wherein the functional material comprises, but is not limited to, the following materials by weight percent: 40-60% of polyhydric alcohol and 40-60% of inorganic ammonium phosphate.

7. The functional thermal insulation device for a lithium battery according to claim 2, wherein the nitrogen-containing organic compound comprises, is not limited to, tripolycyanamide and/or urea.

8. The functional thermal insulation device for a lithium battery according to claim 3, wherein the nitrogen-containing organic compound comprises, is not limited to, tripolycyanamide and/or urea.

9. The functional thermal insulation device for a lithium battery according to claim 4, wherein the nitrogen-containing organic compound comprises, is not limited to, tripolycyanamide and/or urea.

10. The functional thermal insulation device for a lithium battery according to claim 5, wherein the nitrogen-containing organic compound comprises, is not limited to, tripolycyanamide and/or urea.

11. The functional thermal insulation device for a lithium battery according to claim 2, wherein the polyhydric alcohol comprises, but is not limited to, dipentaerythritol.

12. The functional thermal insulation device for a lithium battery according to claim wherein the polyhydric alcohol comprises, but is not limited to, dipentaerythritol.

13. The functional thermal insulation device for a lithium battery according to claim 4, wherein the polyhydric alcohol comprises, but is not limited to, dipentaerythritol.

14. The functional thermal insulation device for a lithium battery according to claim 6, wherein the polyhydric alcohol comprises, but is not limited to, dipentaerythritol.

15. The functional thermal insulation device for a lithium battery according to claim 2, wherein the inorganic ammonium phosphate comprises, but is not limited to, ammonium polyphosphate and/or ammonium dihydrogen phosphate.

16. The functional thermal insulation device for a lithium battery according to claim 5, wherein the inorganic ammonium phosphate comprises, but is not limited to, ammonium polyphosphate and/or ammonium dihydrogen phosphate.

17. The functional thermal insulation device for a lithium battery according to claim 6, wherein the inorganic ammonium phosphate comprises, but is not limited to, ammonium polyphosphate and/or ammonium dihydrogen phosphate.

18. The functional thermal insulation device for a lithium battery according to claim 1, wherein the functional material is of a solid state or liquid state or solid-liquid mixed state.
